(19) United States
(12) Patent Application Publication
(10) Pub. No.: US 2011/0102233 A1
(43) Pub. Date: May 5, 2011

(54) Active millimeter-wave imaging system

(75) Inventor: PAUL JOHNSON, EL CAJON, CA (US)

(73) Assignee: Trex Enterprises Corp.

(21) Appl. No.: 12/283,792

(22) Filed: Sep. 15, 2008

(51) Int. Cl. G01S 13/00

(52) U.S. Cl. 342/22; 342/179

(57) ABSTRACT

An active millimeter wave imaging system and method. The system includes a spatially distributed broadband millimeter-wave illuminating source for illuminating a field of view and a millimeter-wave imaging receiver for imaging the field of view. The subject area to be imaged is illuminated simultaneously from many different angles by the distributed source. Reflections from the subjected area are then collected and used to form images. These images in preferred embodiments are compared with passive images made without the millimeter wave illumination from the millimeter wave source. The spatially distributed illumination source in preferred embodiments includes a broadband millimeter-wave noise generator producing millimeter wave radiation at frequencies at which the passive receiver is sensitive and a large reflector. In preferred embodiments the reflector has the shape of a section of an ellipse defining two foci.

### FIELD OF THE INVENTION

The present invention pertains generally to millimeter-wave imaging and security systems. More particularly, the present invention pertains to personal scanning for contraband detection and portal security.

### BACKGROUND OF THE INVENTION

Millimeter-wave imaging systems are well known in the prior art. Various passive and radar-based active imaging systems using millimeter-wavelength radio frequency (RF) emissions (30-300 GHz) have been developed and tested. An important advantage of millimeter-waves for personal contraband detection is that the millimeter-wave frequencies will penetrate clothing and non-conductive materials to reveal the underlying structure. By collecting the millimeter-wave RF emitted and reflected by persons or objects, images can be obtained that show the structure of items hidden under clothing.

Applicant's assignee has developed a series of passive millimeter wave imaging systems many of which are described in the following patents and patent applications, all of which are incorporated by reference.

| | | Patents | Issued |
|---|---|---|---|
| 1) | Pat. No. 5,121,124 | Microwave Camera | Jun. 09, 1992 |
| 2) | Pat. No. 5,365,237 | Microwave Camera | Nov. 15, 1994 |
| 3) | Pat. No. 6,937,182 | MM Wave Imaging System | Aug. 30, 2005 |
| 4) | Pat. No. 7,019,682 | Imaging MM Wave Radar System | Mar. 28, 2006 |
| 5) | Pat. No. 7,170,442 | Video Rate Passive MM Wave Imaging System | Jan. 30, 2007 |
| 6) | Pat. No. 7,194,236 | MM Wave Imaging System | Mar. 20, 2007 |
| 7) | Pat. No. 7,248,204 | Security System with Metal Detection . . . | Jul. 24, 2008 |
| 8) | Pat. No. 7,385,549 | MM Wave Portal Imaging System | Jun. 10, 2008 |
| 9) | Pat. No. 7,415,244 | Multi-Channel MM Wave Imaging System | Aug. 19, 2008 |
| | | Patent Application | Filed |
| 2) | Ser. No. 11/300,827 | MM Wave Imaging System | Dec. 14, 2005 |

These passive imaging systems when used to detect contraband carried under persons clothing are designed to detect millimeter wave radiation radiated by the person's warm body. This radiation passes through clothing but is stopped by contraband articles such as guns, knives and bombs and these objects show up on the millimeter wave images produced by the imagers.

Active millimeter wave imagers are known in the prior art. However often in the past, illumination of a subject from a single millimeter-wave point source has suffered from ‘glint’, or the extremely bright reflection from objects oriented at a particular angle between the illuminating source and the receiver. This ‘glint’ effect reduces the quality of the image created due to dynamic range limitations in the receiving hardware. On the other hand if the object is oriented at certain other angles the illuminating radiation may be reflected away from the millimeter wave detector and thus not imaged.

What is needed is a better active millimeter wave imaging system and method.

### SUMMARY OF THE INVENTION

The present invention provides an active millimeter wave imaging system and method. The system includes a spatially distributed broadband millimeter-wave illuminating source for illuminating a field of view and a millimeter-wave imaging receiver for imaging the field of view. The subject area to be imaged is illuminated simultaneously from many different angles by the distributed source. Reflections from the subjected area are then collected and used to form images. These images in preferred embodiments are compared with passive images made without the millimeter wave illumination from the millimeter wave source. The spatially distributed illumination source in preferred embodiments includes a broadband millimeter-wave noise generator producing millimeter wave radiation at frequencies at which the passive receiver is sensitive and a large reflector. In preferred embodiments the reflector has the shape of a section of an ellipse defining two foci. The broadband noise generator is placed at one focus, and the subject area to be imaged is placed at approximately the other focus. Millimeter-wave energy is emitted from the generator, strikes the elliptical reflector which approximately refocuses the radiation on the target at the other focus. The millimeter wave energy reflects from or is absorbed by objects at or near the other focus. Some of the reflected radiation is collected by the imaging receiver along with other millimeter wave radiation emitted or reflected from the field of view of the imager. This collected radiation is used by the imaging receiver to form an image of the field of view. In preferred embodiments two images are collected by the imaging receiver, one passive without the illumination and one with the illumination. An image is made from the difference of the two images.

### BRIEF DESCRIPTION OF THE DRAWINGS

FIG. 1 is a diagram of the Active Millimeter-wave Imaging System.

### DETAILED DESCRIPTION OF PREFERRED EMBODIMENTS

### First Preferred Embodiment

In the preferred embodiment of the invention, the millimeter-wave (mmw) noise source generates frequencies in the 78-86 GHz region of the frequency spectrum and a passive millimeter-wave imaging receiver with a frequency (vertical) and phase (horizontal) scanned antenna is used to collect the reflected energy. The passive imaging receiver uses techniques already known to the field such as any of the imaging systems described in the patents and patent applications listed in the Background section of this application.

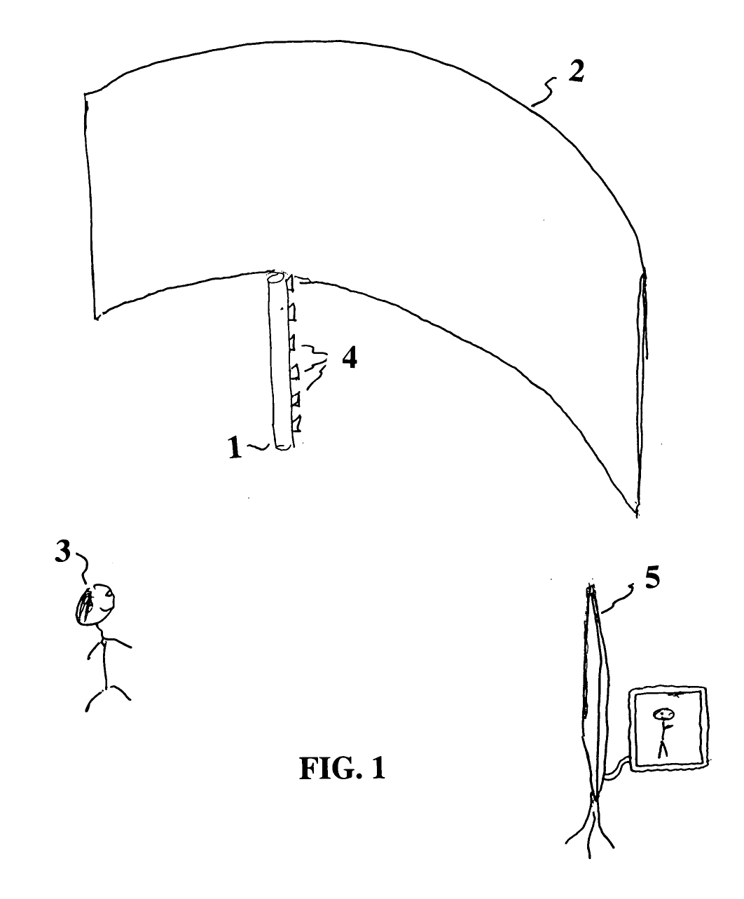

A block diagram of the Active Millimeter-wave Imaging System is shown in FIG. 1. Illumination source 1 is comprised of a vertical array of noise generators 4 generating electromagnetic noise is the frequency range of 75-85 GHz. In a preferred embodiment these generators are each Model #NC5110, manufactured by NoiseCom, Inc., Parsippany, N.J. These generators produce the millimeter wave radiation with a swept-frequency oscillator. In the preferred embodiment, noise generators 4 are replicated six times in a vertical direction, with a spacing of approximately 12 inches between the noise generators. Antenna 2 is a large section of a two-dimensional ellipse, approximately 7 feet tall and 15 feet wide. Illumination source 1 is arranged at one focus of Elliptical antenna 2. Imaging Subject 3 is ordered to stand at approximately the other focus of elliptical antenna 2 and millimeter-wave energy from illumination source 1 illuminates subject 3 after reflection from antenna 2. Millimeter-wave energy reflects in varying amounts from different parts of subject 3, depending on the composition and orientation of the various parts of subject 3. The reflected energy is collected by millimeter-wave imaging receiver 5 and used to form images of subject 3 and display the images on computer display panel 6 in a manner explained in detail in the patents and patent applications listed in the background section. In a preferred embodiment of the invention, metal, plastic, and other items of high density and reflectivity will be revealed beneath the clothing of subject 3.

While the particular active millimeter wave imaging system as herein shown and disclosed in detail is fully capable of obtaining the objects and providing the advantages herein before stated, it is to be understood that it is merely illustrative of the presently preferred embodiments of the invention and that no limitations are intended to the details of constructions or design herein shown other than as described in the appended claims.

For example, various millimeter wave frequency sources may serve as illumination source 1, such as noise generators, swept frequency oscillators, and stepped frequency oscillators. Antenna 2 may take on shapes other than elliptical, allowing for the use of fewer or more illumination sources. Antenna 2 may be eliminated, and the subject directly illuminated by the illumination sources spaced so as to provide illumination from many directions.

Other physical arrangements of the illuminator, the subject and the imager may be formed that allow for illumination of the subject from multiple angles either simultaneously or over some period of time. The imaging device 5 can be placed just in front of the stack of generators 1 between the stack and the target region instead of off to the side as shown in FIG. 1.

The imaging device is preferably a frequency scanned millimeter device as described in of the listed patents. The imaging devices may be a two-dimensional video rate millimeter wave detector or a much less expensive single stick detector which has a narrow vertical field and is scanned in the horizontal direction to produce two-dimensional images. Other millimeter wave detectors could be utilized.

Therefore, the scope of the present invention should be determined by the appended claims and their equivalents and not by the examples that have been given.

What is claimed is:

1. An active millimeter-wave imaging system comprising:
A) an illumination source adapted to generate electromagnetic radiation at least one frequency range between 30 GHz and 300 GHz and to illuminate a field of view from a plurality of directions;
B) a millimeter wave imaging device adapted to collect millimeter wave radiation from a portion or all of the field of view and to produce millimeter wave images from the collected radiation.

2. The active millimeter-wave imaging system as in claim 1 wherein said illumination source 1 comprises a broadband noise generator.

3. The active millimeter-wave imaging system as in claim 1 wherein said illumination source 1 comprises a swept-frequency oscillator.

4. The active millimeter-wave imaging system as in claim 1 wherein the illuminating comprises an elliptical reflector antenna.

5. The active millimeter-wave imaging system as in claim 1 wherein the illuminating comprises an array of spatially distributed illumination sources.

6. A method of searching for contraband hidden beneath clothing of persons comprising the steps of:
A) providing an illumination source adapted to generate electromagnetic radiation at least one frequency range between 30 GHz and 300 GHz to illuminate a field of view from a plurality of directions;
B) providing a millimeter wave imaging device adapted to collect millimeter wave radiation from a portion or all of the field of view and to produce millimeter wave images from the collected radiation;
C) arranging for a person possibly carrying contraband under his clothing to stand in the field of view;
D) illuminating the person with the illumination source and produce images of the person and any hidden contraband with the imaging device.
